(19) United States
(12) Patent Application Publication
(10) Pub. No.: US 2024/0357457 A1
(43) Pub. Date: Oct. 24, 2024

(54) WIRELESS FIXED-LINE TELEPHONE ROUTER, COMMUNICATION CONTROL METHOD AND COMPUTER PROGRAM

(71) Applicant: NIPPON TELEGRAPH AND TELEPHONE CORPORATION, Tokyo (JP)

(72) Inventors: Masaki SHIMA, Musashino-shi, Tokyo (JP); Takeshi ONIZAWA, Musashino-shi, Tokyo (JP); Fumihiro YAMASHITA, Musashino-shi, Tokyo (JP)

(73) Assignee: NIPPON TELEGRAPH AND TELEPHONE CORPORATION, Tokyo (JP)

(21) Appl. No.: 18/687,671

(22) PCT Filed: Sep. 6, 2021
(86) PCT No.: PCT/JP2021/032720

§ 371 Date: Feb. 28, 2024

(51) Int. Cl. H04W 36/14; H04W 36/00; H04W 36/30; H04W 40/12; H04W 88/18

(52) U.S. Cl. CPC H04W 36/142; H04W 36/0016; H04W 36/304; H04W 40/12; H04W 88/18

(57) ABSTRACT

A wireless fixed-line phone router to which at least a wireless fixed-line phone is connected includes a first communication unit that performs communication according to a first mobile communication standard, a second communication unit that performs communication according to a second mobile communication standard that is a mobile communication standard different from the first mobile communication standard and is capable of performing communication in a wider range than the first mobile communication standard, and a control unit that causes the second communication unit to perform communication in a case where communication quality deteriorates when the first communication unit performs communication.

### TECHNICAL FIELD

The present invention relates to a wireless fixed-line phone router, a communication control method, and a computer program.

### BACKGROUND ART

Wireless fixed-line phones (hereinafter referred to as a “wireless fixed-line phone router”) that are wireless fixed-line phones installed in homes have been studied (see, for example, Non Patent Literature 1). Further, some wireless fixed-line phone routers can use Long Term Evolution (LTE, registered trademark) communication capabilities. The conventional wireless fixed-line phone routers are used only for telephone and facsimile, and thus do not need the LTE categories 2 to 17 (hereinafter referred to as “LTE Cat. 2 to 17”) for high-speed communication. Thus, in many cases, the conventional wireless fixed-line phone routers use a communication module of LTE category 1 (hereinafter referred to as “LTE Cat. 1”) of low speed (maximum downlink 10 Mbps/maximum uplink 5 Mbps) that has relatively low power consumption and can be reduced in cost.

FIG. 18 is a block diagram illustrating a configuration of conventional wireless fixed-line phone router 100. For example, a FAX 200 or a subscriber phone 300 is connected to the wireless fixed-line phone router 100. A wireless fixed-line phone router 100 includes a subscriber line interface circuit 110, an audio encoding/decoding unit 120, a FAX encoding/decoding unit 130, an application software unit 140, a control unit 150, a storage unit 160, a communication control unit 170, a subscriber information recording medium 180, and a communication unit 190.

The FAX 200 or the subscriber phone 300 is connected to the subscriber line interface circuit 110. The subscriber line interface circuit 110 inputs and outputs a signal to and from the connected FAX 200 or subscriber phone 300. For example, the subscriber line interface circuit 110 outputs a signal output from the FAX 200 to the FAX encoding/decoding unit 130, and outputs a signal output from the subscriber phone 300 to the audio encoding/decoding unit 120. For example, the subscriber line interface circuit 110 outputs a signal output from the audio encoding/decoding unit 120 to the subscriber phone 300, and outputs a signal output from the FAX encoding/decoding unit 130 to the FAX 200.

The audio encoding/decoding unit 120 encodes or decodes the input audio signal. The FAX encoding/decoding unit 130 encodes or decodes the input signal. The application software unit 140 is an application program for implementing functions in the wireless fixed-line phone router 100. The control unit 150 controls the operation of each functional unit included in the wireless fixed-line phone router 100. The storage unit 160 stores various types of information.

The communication control unit 170 is a communication module for implementing a communication standard of the LTE system. The communication control unit 170 includes a communication control software unit 171 and a baseband control unit 172. The communication control software unit 171 is software for implementing the function of the communication standard of LTE Cat. 1. The baseband control unit 172 performs communication control of LTE Cat. 1. The subscriber information recording medium 180 is a recording medium in which subscriber information is recorded. For example, the subscriber information recording medium 180 is a subscriber identity module (SIM) card or an embedded SIM (eSIM). In the subscriber information recording medium 180, information such as user information (for example, a phone number assigned to the subscriber), subscription information, a registered public land mobile network (RPLMN), a home PLMN (HPLMN), and an operator PLMN (OPLMN) is recorded.

RPLMN represents the last connected company. HPLMN represents a company that has issued the subscriber information recording medium 180. OPLMN represents a preferred connection destination when there is no base station apparatus of the HPLMN. The communication unit 190 includes one or more antennas 191 and communicates with a base station apparatus.

Here, operation of the conventional wireless fixed-line phone router 100 will be described. FIG. 19 is a diagram illustrating a flow of connection processing with the base station apparatus at the time of activation of the conventional wireless fixed-line phone router 100. The wireless fixed-line phone router 100 acquires notification information of Cat. 1 cell (step S11). The Cat. 1 cell represents a communicable area provided by the base station apparatus in the LTE Cat. 1 function. Here, it is assumed that the wireless fixed-line phone router 100 grasps that Cat. 1 cell is in non-communication based on the acquired notification information. Thereafter, the wireless fixed-line phone router 100 turns on the power supply (step S12).

The communication control software unit 171 acquires various types of information recorded in the subscriber information recording medium 180 (step S13). The communication control software unit 171 outputs the acquired various types of information to the baseband control unit 172. The baseband control unit 172 performs a cell search process on the basis of the output various types of information (step S14). The cell search process is a process of detecting a cell to which the wireless fixed-line phone router 100 connects for communication. Here, it is assumed that a Cat. 1 cell is detected. Thereafter, the baseband control unit 172 measures reference signal received power (RSRP) and reference signal received quality (RSRQ) of the reference signal of the Cat. 1 cell (step S15). The baseband control unit 172 outputs the measured RSRP and RSRQ to the control unit 150.

The control unit 150 creates an MR of the Cat. 1 cell on the basis of the RSRP and the RSRQ output from the baseband control unit 172. The control unit 150 outputs the created MR to the baseband control unit 172. The baseband control unit 172 transmits the MR to the base station apparatus via the communication unit 190 (step S16). The baseband control unit 172 connects to the Cat. 1 cell on the basis of information related to the setting of a wireless link to the Cat. 1 cell transmitted from the base station apparatus (step S17). In the following description, a cell to which the wireless fixed-line phone router 100 is connected is also referred to as a serving cell.

Next, a flow of handover processing in the conventional wireless fixed-line phone router 100 will be described. FIG. 20 is a diagram illustrating a flow of handover processing of the conventional wireless fixed-line phone router 100. Here, a flow of handover from a Cat. 1 cell to which the wireless fixed-line phone router 100 is connected to another cell in the processing illustrated in FIG. 19 will be described. The baseband control unit 172 measures the RSRP and the RSRQ of the serving cell (for example, Cat. 1 cell) (step S21).

The baseband control unit 172 determines whether or not it is necessary to create a measurement report (MR) on the basis of the measured RSRP and RSRQ (step S22). When either the measured RSRP or RSRQ is less than a threshold value, the baseband control unit 172 determines that it is necessary to create the MR. The fact that either the RSRP or the RSRQ is less than the threshold value means that the reception strength or the reception quality is deteriorated. When it is determined that it is not necessary to create the MR (step S22—NO), the baseband control unit 172 returns to the process of step S21 and performs the process.

On the other hand, when it is determined that it is necessary to create the MR (step S22—YES), the baseband control unit 172 measures the RSRP and the RSRQ of the serving cell and the RSRP and the RSRQ of the cell adjacent to the wireless fixed-line phone router 100. The baseband control unit 172 outputs the measured RSRP and RSRQ to the control unit 150. The control unit 150 creates the MR on the basis of the RSRP and the RSRQ output from the baseband control unit 172 (step S23). FIG. 21 is a diagram illustrating an example of an MR created on the basis of RSRP and RSRQ measured in a serving cell and a cell adjacent to the wireless fixed-line phone router 100.

The control unit 150 outputs the created MR to the baseband control unit 172. The baseband control unit 172 transmits the MR to the base station apparatus providing the serving cell via the communication unit 190 (step S24).

The baseband control unit 172 receives an instruction of handover from the base station apparatus providing the serving cell via the communication unit 190 (step S25). The instruction of handover includes information related to setting of a wireless link of a new connection destination. The baseband control unit 172 disconnects the wireless link of the serving cell on the basis of the received instruction of handover (step S26). The baseband control unit 172 sets a wireless link of a cell as a new connection destination on the basis of the information regarding the setting of the wireless link included in the instruction of handover (step S27).

After completing the setting of the wireless link, the wireless fixed-line phone router 100 establishes a data communication path of an uplink user packet of the cell as the new connection destination (step S28). After completing the setting of the wireless link, the wireless fixed-line phone router 100 establishes a data communication path of a downlink user packet of the cell as the new connection destination (step S29). Thus, the wireless fixed-line phone router 100 can handover to other cells.

As described above, in LTE, when a UE (here, the wireless fixed-line phone router 100) performs handover to another cell, reception quality (RSRP and RSRQ) of a reference signal in the serving cell and an adjacent cell is measured in the UE, and an MR is transmitted as a reception quality measurement result from the UE to the base station apparatus. The base station apparatus transmits RRC Connection Reconfiguration including information of the base station apparatus as a connection destination of the UE to the UE on the basis of the received MR. The UE performs handover to the transition destination on the basis of the received RRC Connection Reconfiguration.

### CITATION LIST

### Non Patent Literature

Non Patent Literature 1: “Joho tsushin shingikai joho tsushin gijutsu bunkakai IP network setsubi iinkai waiyaresu kotei denwa kento sagyo houkoku (an) gaiyou-waiyaresu kotei denwa you setsubi ni kakawaru gijutsu teki jyouken- (IP Network Facilities Committee, Subcommittee on Information and Communications Technology, Information and Communication Council, Report (Draft) Summary of Working Group for Study of Wireless Fixed-line Phone-Technical Requirements for Wireless Fixed-line Phone Facilities-) “, [online], [Searched on Sep. 6, 2021], the Internet <https://www.soumu.go.jp/main_content/000706846.pdf>

### SUMMARY OF INVENTION

### Technical Problem

However, in a ruler area, since the number of mobile phone base stations is small with respect to the size of the area, it is also assumed a case where the existing fixed-line phone use location is outside the cell coverage of the existing mobile phone base station, and there may be a case where the wireless fixed-line phone cannot be used. In such a case, there is a problem that the wireless fixed-line phone cannot be used.

In view of the above circumstances, it is an object of the present invention to provide a technique capable of maintaining communication of a wireless fixed-line phone more than before.

### Solution to Problem

One aspect of the present invention is a wireless fixed-line phone router to which at least a wireless fixed-line phone is connected, the wireless fixed-line phone router including a first communication unit that performs communication according to a first mobile communication standard, a second communication unit that performs communication according to a second mobile communication standard that is a mobile communication standard different from the first mobile communication standard and is capable of performing communication in a wider range than the first mobile communication standard, and a control unit that causes the second communication unit to perform communication in a case where communication quality deteriorates when the first communication unit performs communication.

One aspect of the present invention is a communication control method performed by a wireless fixed-line phone router to which at least a wireless fixed-line phone is connected, the communication control method including performing communication according to a first mobile communication standard, performing communication according to a second mobile communication standard that is a mobile communication standard different from the first mobile communication standard and is capable of performing communication in a wider range than the first mobile communication standard, and causing communication to be performed by the second mobile communication standard in a case where communication quality deteriorates when communication is performed by the first mobile communication standard.

One aspect of the present invention is a computer program for causing a computer to function as the wireless fixed-line phone router described above.

### Advantageous Effects of Invention

According to the present invention, it is possible to maintain communication of a wireless fixed-line phone more than before.

### BRIEF DESCRIPTION OF DRAWINGS

FIG. 1 is a diagram illustrating a system configuration of a wireless communication system according to the present invention.

FIG. 2 is a block diagram illustrating a configuration of a wireless fixed-line phone router according to the present invention.

FIG. 3 is a diagram for describing an outline of processing of the wireless fixed-line phone router in a first operation example.

FIG. 4 is a diagram for describing an outline of processing of the wireless fixed-line phone router in the first operation example.

FIG. 5 is a diagram for describing an outline of processing of the wireless fixed-line phone router in the first operation example.

FIG. 6 is a diagram for describing an outline of processing of the wireless fixed-line phone router in the first operation example.

FIG. 7 is a diagram for describing an outline of processing of the wireless fixed-line phone router in the first operation example.

FIG. 8 is a diagram illustrating a flow of connection processing with a base station apparatus at a time of activation of the wireless fixed-line phone router according to the present invention.

FIG. 9 is a diagram illustrating a flow of handover processing (part 1) of the wireless fixed-line phone router according to the present invention.

FIG. 10 is a diagram illustrating an example of an MR created using an MR of a first cell and an MR of a second cell.

FIG. 11 is a diagram illustrating a flow of handover processing (part 2) of the wireless fixed-line phone router according to the present invention.

FIG. 12 is a diagram for describing an outline of processing of the wireless fixed-line phone router in a second operation example.

FIG. 13 is a diagram for describing an example of a method of monitoring voice call quality deterioration using voice communication RTCP information.

FIG. 14 is a diagram illustrating an example of a format of an RTCP receiver report packet in the second operation example.

FIG. 15 is a diagram for describing a method of reflecting voice call quality deterioration information on an MR at a time of handover due to voice call quality deterioration in a second operation example.

FIG. 16 is a diagram illustrating a flow of handover processing (part 3) of the wireless fixed-line phone router according to the present invention.

FIG. 17 is a diagram illustrating a flow of handover processing (part 4) of the wireless fixed-line phone router according to the present invention.

FIG. 18 is a block diagram illustrating a configuration of a conventional wireless fixed-line phone router.

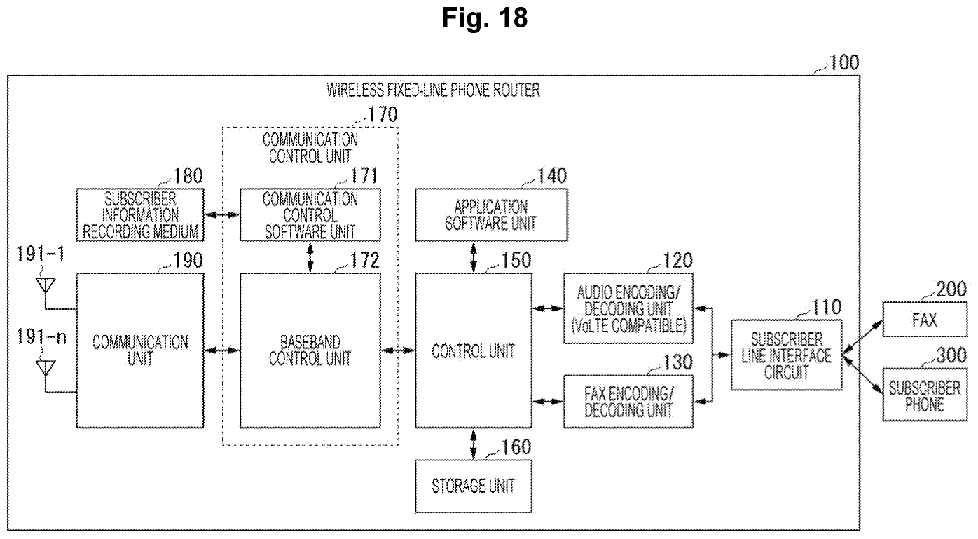

FIG. 19 is a diagram illustrating a flow of connection processing with a base station apparatus at a time of activation of the conventional wireless fixed-line phone router.

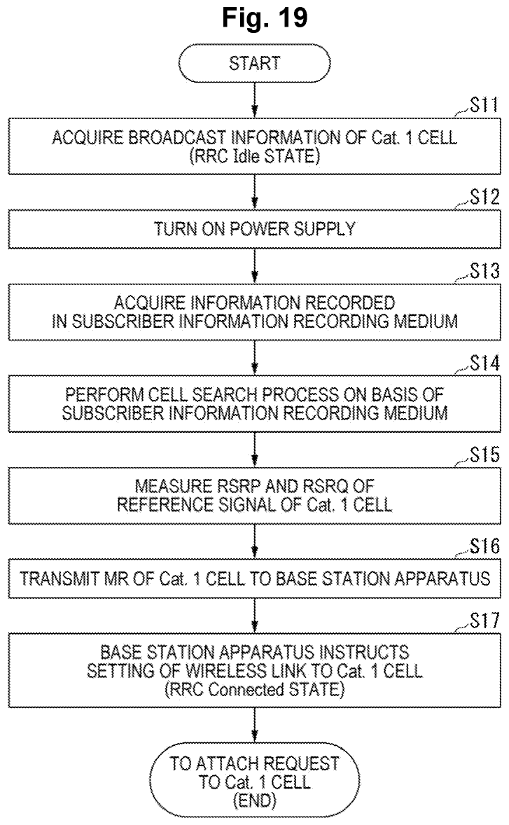

FIG. 20 is a diagram illustrating a flow of handover processing of the conventional wireless fixed-line phone router.

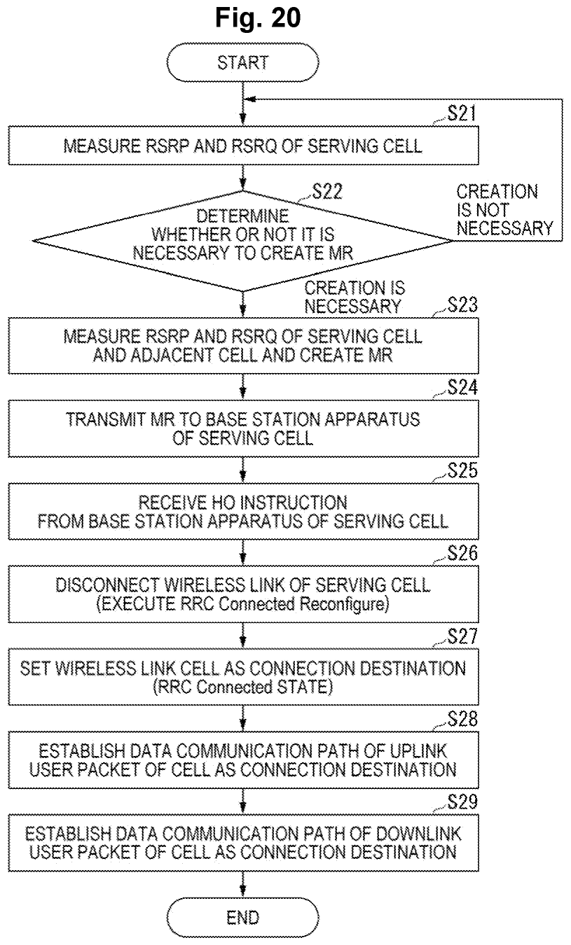

FIG. 21 is a diagram illustrating an example of an MR created on the basis of RSRP and RSRQ measured in a cell adjacent to a serving cell and the wireless fixed-line phone router.

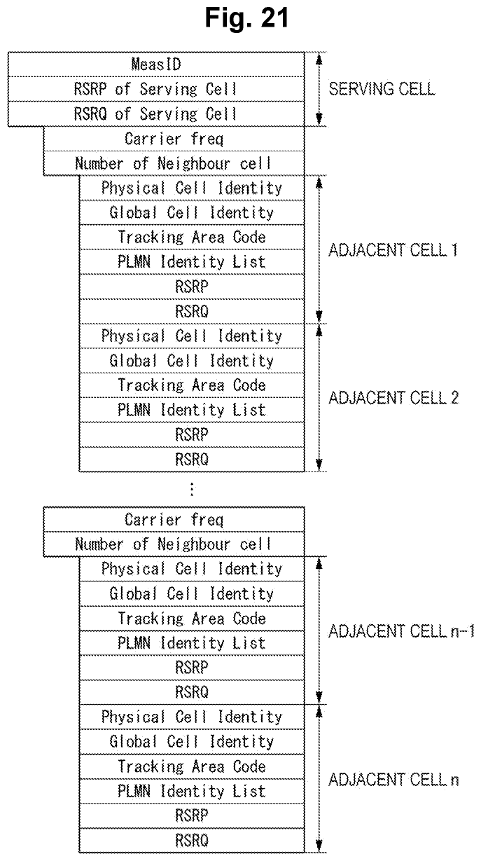

### DESCRIPTION OF EMBODIMENTS

Hereinafter, embodiments of the present invention will be described with reference to drawings.

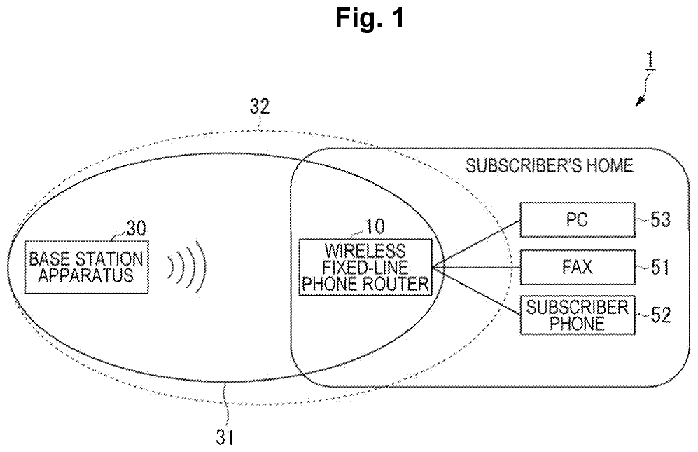

FIG. 1 is a diagram illustrating a system configuration of a wireless communication system 1 according to the present invention. The wireless communication system 1 includes a wireless fixed-line phone router 10 and a base station apparatus 30. Note that the wireless communication system 1 may include a plurality of wireless fixed-line phone routers 10 and a plurality of base station apparatuses 30.

The wireless fixed-line phone router 10 is an apparatus installed in a subscriber's home. The wireless fixed-line phone router 10 has two types of functions of LTE Cat. 1 to 17 and LTE Cat. M1 for one subscriber information recording medium as an LTE communication function of the wireless fixed-line phone. Since LTE Cat. M1 has a coverage enhancement function, a range of cells that can be connected is wider than that of LTE Cat. 1 to 17. Furthermore, since the wireless fixed-line phone router 10 also has the functions of LTE Cat. 2 to 17, it is also possible to connect a device of a personal computer that performs high-speed communication. For example, a FAX 51, a subscriber phone 52, or a personal computer (PC) 53 is connected to the wireless fixed-line phone router 10.

The base station apparatus 30 is a base station apparatus capable of performing communication in LTE. The base station apparatus 30 provides a communicable area (hereinafter referred to as a “first cell”) 31 that enables communication of the LTE Cat. 1 to 17 standards and a communicable area (hereinafter referred to as a “second cell”) 32 that enables communication of the LTE Cat. M1 standard.

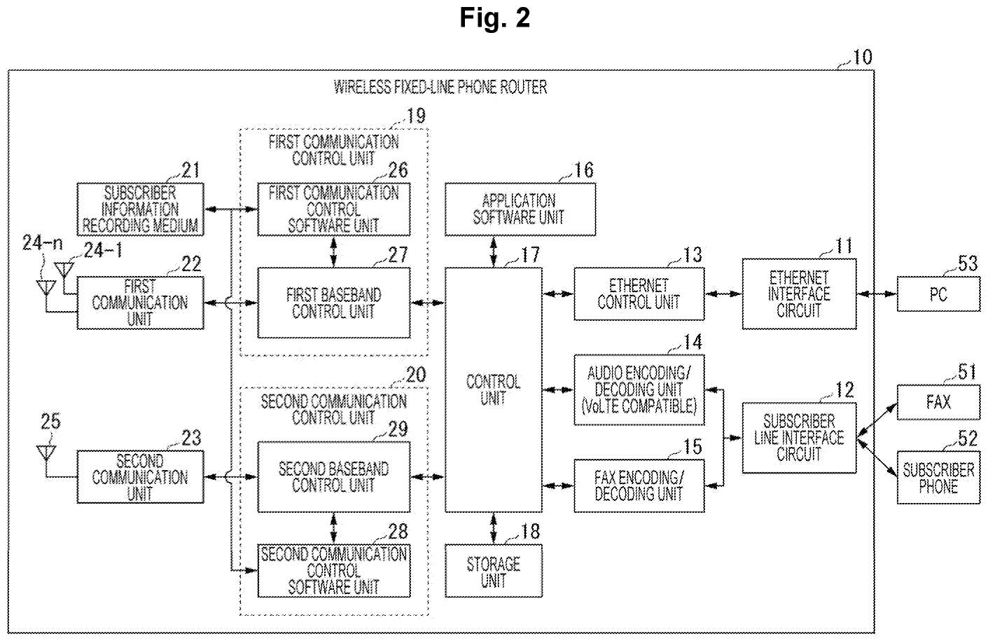

FIG. 2 is a block diagram illustrating a configuration of the wireless fixed-line phone router 10 according to the present invention. The wireless fixed-line phone router 10 includes an Ethernet interface circuit 11, a subscriber line interface circuit 12, an Ethernet control unit 13, an audio encoding/decoding unit 14, a FAX encoding/decoding unit 15, an application software unit 16, a control unit 17, a storage unit 18, a first communication control unit 19, a second communication control unit 20, a subscriber information recording medium 21, a first communication unit 22, and a second communication unit 23.

The PC 53 is connected to the Ethernet interface circuit 11. The Ethernet interface circuit 11 inputs and outputs a signal to and from the connected PC 53. For example, the Ethernet interface circuit 11 outputs a signal output from the PC 53 to the Ethernet control unit 13. For example, the Ethernet interface circuit 11 outputs a signal output from the Ethernet control unit 13 to the PC 53.

The FAX 51 or the subscriber phone 52 is connected to the subscriber line interface circuit 12. The subscriber line interface circuit 12 inputs and outputs a signal to and from the connected FAX 51 or the subscriber phone 52. For example, the subscriber line interface circuit 12 outputs a signal output from the FAX 51 to the FAX encoding/decoding unit 15, and outputs a signal output from the subscriber phone 52 to the audio encoding/decoding unit 14. For example, the subscriber line interface circuit 12 outputs a signal output from the audio encoding/decoding unit 14 to the subscriber phone 52, and outputs a signal output from the FAX encoding/decoding unit 15 to the FAX 51.

The Ethernet control unit 13 transfers the signal output from the Ethernet interface circuit 11 to the control unit 17. The Ethernet control unit 13 transfers a signal output from the control unit 17 to the Ethernet interface circuit 11.

The audio encoding/decoding unit 14 encodes or decodes the input audio signal.

The FAX encoding/decoding unit 15 encodes or decodes the input signal.

The application software unit 16 is an application program for implementing functions in the wireless fixed-line phone router 10.

The control unit 17 controls the operation of each functional unit included in the wireless fixed-line phone router 100. Specifically, the control unit 17 switches the communication standard (LTE Cat. 1 to 17 or LTE Cat. M1) used by the wireless fixed-line phone router 10. The control unit 17 switches the communication standard (LTE Cat. 1 to 17 or LTE Cat. M1) upon detecting degradation of radio quality in the serving cell.

The storage unit 18 stores various types of information.

The first communication control unit 19 is a communication module for implementing the communication standards of LTE Cat. 1 to 17. The first communication control unit 19 includes a first communication control software unit 26 and a first baseband control unit 27. The first communication control software unit 26 is software for implementing the functions of the communication standards of LTE Cat. 1 to 17. The first baseband control unit 27 performs communication control of LTE Cat. 1 to 17.

The second communication control unit 20 is a communication module for implementing the communication standard of LTE Cat. M1. The second communication control unit 20 includes a second communication control software unit 28 and a second baseband control unit 29. The second communication control software unit 28 is software for implementing the function of the communication standard of LTE Cat. M1. The second baseband control unit 29 performs communication control of LTE Cat. M1.

The subscriber information recording medium 21 is a recording medium in which subscriber information is recorded. For example, the subscriber information recording medium 21 is a SIM card or an eSIM. In the subscriber information recording medium 21, information such as user information (for example, a phone number assigned to the subscriber), subscription information, RPLMN, HPLMN, and OPLMN is recorded.

The first communication unit 22 includes one or more antennas 24 and communicates with the base station apparatus 30. For example, the first communication unit 22 communicates with the base station apparatus 30 in a first cell 31 provided by the base station apparatus 30.

The second communication unit 23 includes one or more antennas 25 and communicates with the base station apparatus. The second communication unit 23 communicates with the base station apparatus 30 in the second cell 32 provided by the base station apparatus 30.

The wireless fixed-line phone router 10 performs data communication using a signal input from the FAX 51 or the PC 53 and a voice call using an audio signal input from the subscriber phone 52, and processing of the wireless fixed-line phone router 10 at the time of data communication or voice call will be described below.

### First Operation Example

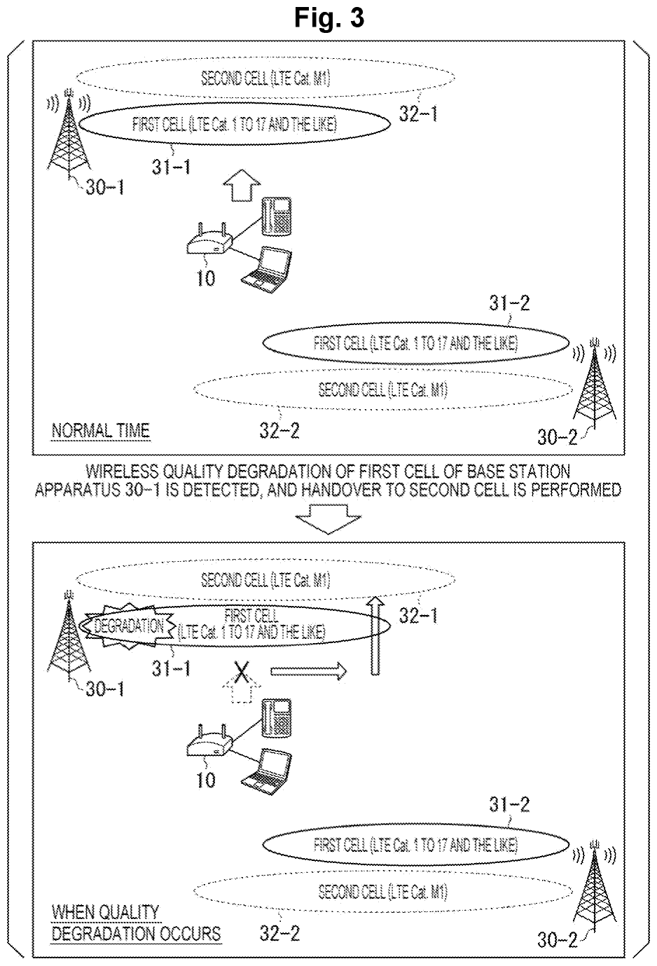

First, as a first operation example of the wireless fixed-line phone router 10, processing at the time of data communication using a signal input from the FAX 51 or the PC 53 will be described. FIGS. 3 to 7 are diagrams for describing an outline of processing of the wireless fixed-line phone router 10 in the first operation example. In FIG. 3, a flow in a case where the wireless fixed-line phone router 10 performs handover to a second cell 32-1 provided by a base station apparatus 30-1 will be described. In FIG. 3, the wireless fixed-line phone router 10 is located in a first cell 31-1 and a second cell 32-1 provided by the base station apparatus 30-1, and a second cell 32-2 provided by a base station apparatus 30-2. In FIG. 3, it is assumed that the relationship of RSRP/RSRQ in each cell measured by the wireless fixed-line phone router 10 is as follows.

### (Relationship of RSRP/RSRQ in Each Cell Illustrated in FIG. 3)

RSRP/RSRQ measured in the first cell 31-1>RSRP/RSRQ measured in second cell 32-1>RSRP/RSRQ measured in second cell 32-2

In a case of the above relationship, the wireless fixed-line phone router 10 connects to the first cell 31-1 having the highest communication quality to perform communication during normal time. Thereafter, when the wireless fixed-line phone router 10 detects (for example, RSRP or RSRQ is less than a threshold value) radio quality degradation of the first cell 31-1, as illustrated in the lower diagram of FIG. 3 (when quality degradation occurs), the wireless fixed-line phone router 10 connects to the second cell 32-1 that is connectable and has the second highest communication quality. At this time, the wireless fixed-line phone router 10 performs communication using the second communication control unit 20 instead of the first communication control unit 19. Note that it is possible to use the fixed-line phone.

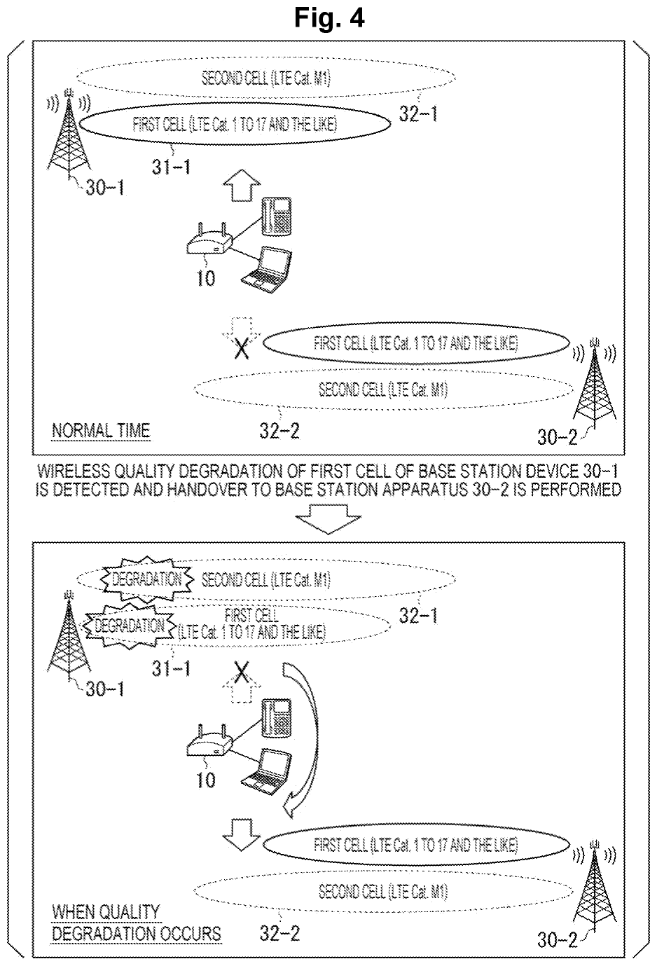

In FIG. 4, a flow in a case where the wireless fixed-line phone router 10 performs handover to the second cell 32-2 provided by the base station apparatus 30-2 will be described. In FIG. 4, the wireless fixed-line phone router 10 is located in the first cell 31-1 and the second cell 32-1 provided by the base station apparatus 30-1, and the second cell 32-2 provided by the base station apparatus 30-2. In FIG. 4, it is assumed that the relationship of RSRP/RSRQ in each cell measured by the wireless fixed-line phone router 10 is as follows.

### (Relationship of RSRP/RSRQ in Each Cell Illustrated in FIG. 4)

RSRP/RSRQ measured in the first cell 31-1>RSRP/RSRQ measured in second cell 32-1>RSRP/RSRQ measured in second cell 32-2

In a case of the above relationship, the wireless fixed-line phone router 10 connects to the first cell 31-1 having the highest communication quality to perform communication during normal time. Thereafter, when the wireless fixed-line phone router 10 detects (for example, RSRP or RSRQ is less than a threshold value) radio quality degradation of the first cell 31-1 and the second cell 32-1, the wireless fixed-line phone router 10 connects to the connectable second cell 32-2 as illustrated in the lower diagram of FIG. 4 (when quality degradation occurs). At this time, the wireless fixed-line phone router 10 performs communication using the second communication control unit 20 instead of the first communication control unit 19. Note that it is possible to use the fixed-line phone.

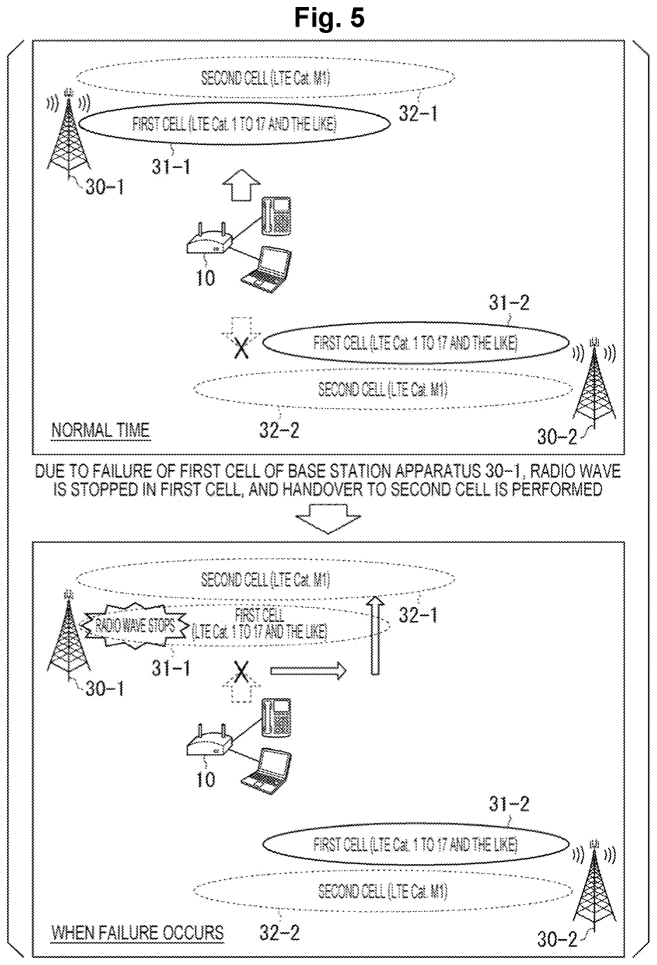

In FIG. 5, a flow in a case where the wireless fixed-line phone router 10 performs handover to the second cell 32-1 provided by the base station apparatus 30-1 will be described. In FIG. 5, the wireless fixed-line phone router 10 is located in the first cell 31-1 and the second cell 32-1 provided by the base station apparatus 30-1, and the second cell 32-2 provided by the base station apparatus 30-2. In FIG. 5, it is assumed that the relationship of RSRP/RSRQ in each cell measured by the wireless fixed-line phone router 10 is as follows.

### (Relationship of RSRP/RSRQ in Each Cell Illustrated in FIG. 5)

RSRP/RSRQ measured in the first cell 31-1>RSRP/RSRQ measured in second cell 32-1>RSRP/RSRQ measured in second cell 32-2

In a case of the above relationship, the wireless fixed-line phone router 10 connects to the first cell 31-1 having the highest communication quality to perform communication during normal time. Thereafter, when the wireless fixed-line phone router 10 detects that the radio wave is stopped (for example, RSRP or RSRQ cannot be measured) in the first cell 31-1 due to a failure at the base station apparatus 30-1, the wireless fixed-line phone router 10 connects to the second cell 32-1 that is connectable and has the second highest communication quality as illustrated in the lower diagram of FIG. 5 (when a failure occurs). At this time, the wireless fixed-line phone router 10 performs communication using the second communication control unit 20 instead of the first communication control unit 19. Note that it is possible to use the fixed-line phone.

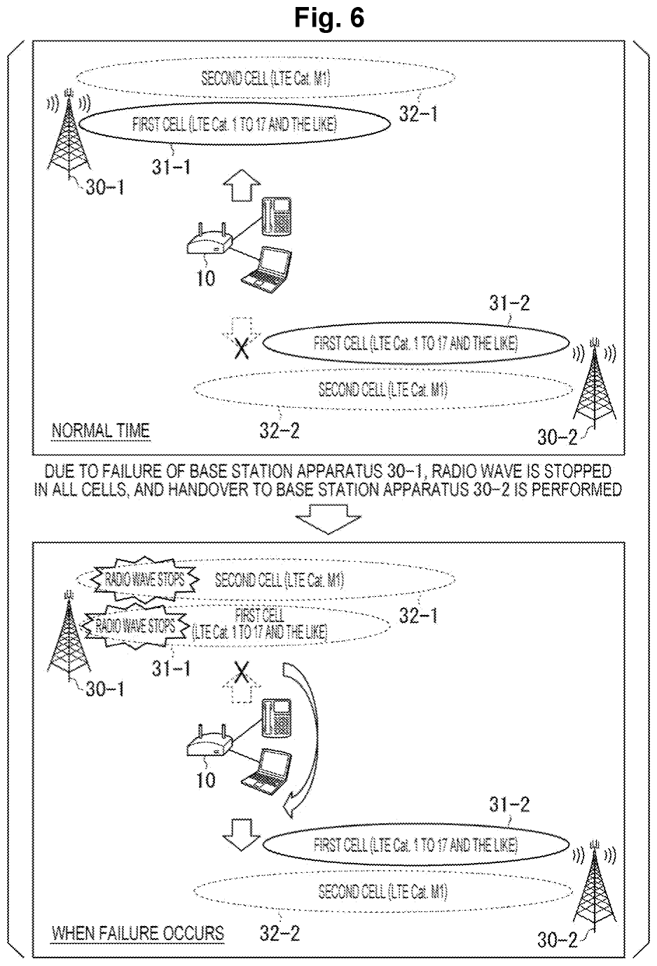

In FIG. 6, a flow in a case where the wireless fixed-line phone router 10 performs handover to the second cell 32-2 provided by the base station apparatus 30-2 will be described. In FIG. 6, the wireless fixed-line phone router 10 is located in the first cell 31-1 and the second cell 32-1 provided by the base station apparatus 30-1, and the second cell 32-2 provided by the base station apparatus 30-2. In FIG. 6, it is assumed that the relationship of RSRP/RSRQ in each cell measured by the wireless fixed-line phone router 10 is as follows.

### (Relationship of RSRP/RSRQ in Each Cell Illustrated in FIG. 6)

RSRP/RSRQ measured in the first cell 31-1>RSRP/RSRQ measured in second cell 32-1>RSRP/RSRQ measured in second cell 32-2

In a case of the above relationship, the wireless fixed-line phone router 10 connects to the first cell 31-1 having the highest communication quality to perform communication during normal time. Thereafter, when the wireless fixed-line phone router 10 detects that a radio wave is stopped (for example, RSRP or RSRQ cannot be measured) in all the cells of the first cell 31-1 and the second cell 32-1 due to a failure at the base station apparatus 30-1, the wireless fixed-line phone router 10 connects to the connectable second cell 32-2 as illustrated in the lower diagram of FIG. 6 (when a failure occurs). At this time, the wireless fixed-line phone router 10 performs communication using the second communication control unit 20 instead of the first communication control unit 19. Note that it is possible to use the fixed-line phone.

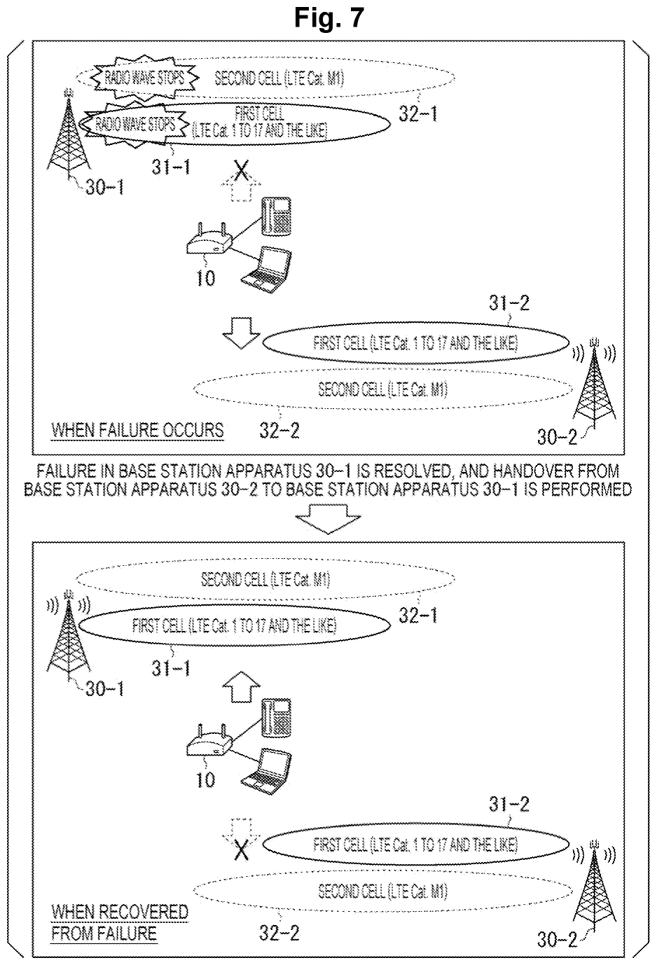

In FIG. 7, a flow in a case where the failure of the base station apparatus 30-1 is resolved from the situation at the time of occurrence of the failure in FIG. 6 and the wireless fixed-line phone router 10 performs handover to the first cell 31-1 provided by the base station apparatus 30-1 will be described. In FIG. 7, the wireless fixed-line phone router 10 is located in the first cell 31-1 and the second cell 32-1 provided by the base station apparatus 30-1, and the second cell 32-2 provided by the base station apparatus 30-2. When a failure occurs, the wireless fixed-line phone router 10 connects to the second cell 32-2 to perform communication.

Thereafter, when the wireless fixed-line phone router 10 detects that the failure of the base station apparatus 30-1 is resolved (for example, RSRP or RSRQ can be measured), the wireless fixed-line phone router 10 measures RSRP/RSRQ in the first cell 31-1 and the second cell 32-1 provided by the base station apparatus 30-1. In FIG. 7, it is assumed that the relationship of RSRP/RSRQ in each cell measured by the wireless fixed-line phone router 10 is as follows.

### (Relationship of RSRP/RSRQ in Each Cell Illustrated in FIG. 7)

RSRP/RSRQ measured in the first cell 31-1>RSRP/RSRQ measured in second cell 32-1>RSRP/RSRQ measured in second cell 32-2

In a case of the above relationship, as illustrated in the lower diagram of FIG. 7 (when recovered from a failure), the wireless fixed-line phone router 10 connects to the first cell 31-1 that can be connected and has the highest communication quality. At this time, the wireless fixed-line phone router 10 performs communication using the first communication control unit 19 instead of the second communication control unit 20.

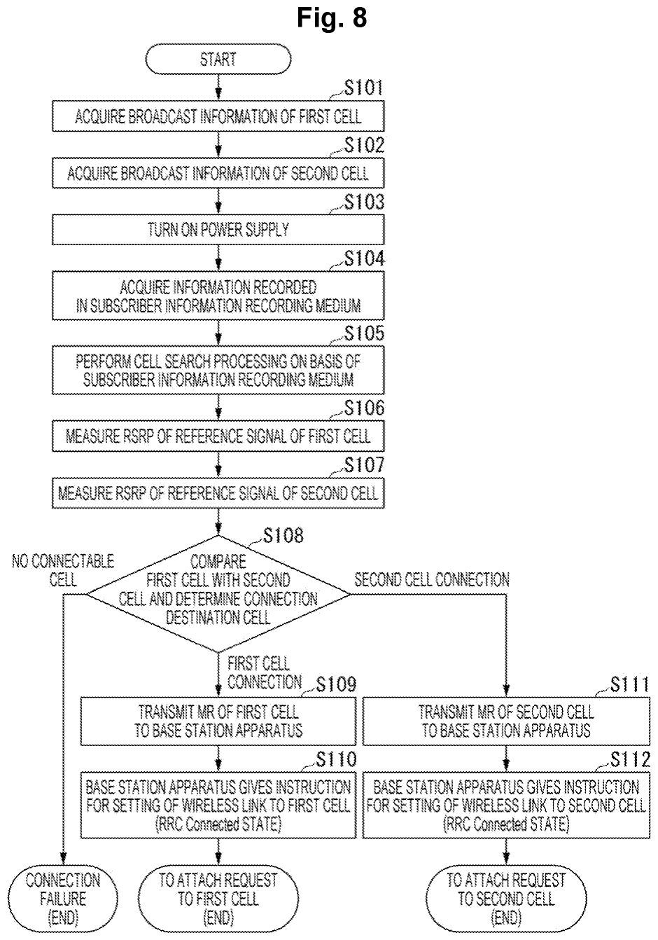

FIG. 8 is a diagram illustrating a flow of connection processing with the base station apparatus 30 at the time of activation of the wireless fixed-line phone router 10 according to the present invention. The wireless fixed-line phone router 10 acquires notification information of the first cell (step S101). Further, the wireless fixed-line phone router 10 acquires the notification information of the second cell (step S102). Thereafter, the wireless fixed-line phone router 100 turns on the power supply (step S103).

The first communication control software unit 26 acquires various types of information recorded in the subscriber information recording medium 21 (step S104). The first communication control software unit 26 outputs the acquired various types of information to the first baseband control unit 27. The first baseband control unit 27 performs cell search process on the basis of the output various types of information (step S105). Here, it is assumed that the first cell 31 and the second cell 32 are detected. The first baseband control unit 27 measures the RSRP of the reference signal of the first cell 31 (step S106). The first baseband control unit 27 outputs the RSRP measured in the first cell 31 to the control unit 17.

The second baseband control unit 29 measures the RSRP of the reference signal of the second cell 32 (step S106). The second baseband control unit 29 outputs the RSRP measured in the second cell 32 to the control unit 17. The control unit 17 compares the RSRP measured in the first cell 31 with the RSRP measured in the second cell 32 and determines a cell as a connection destination (step S108). When each of the RSRP measured in the first cell 31 and the RSRP measured in the second cell 32 is less than the threshold value, the control unit 17 determines that there is no connectable cell.

In a case where each of the RSRP measured in the first cell 31 and the RSRP measured in the second cell 32 is equal to or more than the threshold value, and the RSRP measured in the first cell 31 is larger than the RSRP measured in the second cell 32, the control unit 17 determines that the cell as the connection destination is the first cell 31. When each of the RSRP measured in the first cell 31 and the RSRP measured in the second cell 32 is equal to or larger than the threshold value and the RSRP measured in the second cell 32 is larger than the RSRP measured in the first cell 31, the control unit 17 determines that the cell as the connection destination is the second cell 32.

When it is determined that there is no connectable cell (step S108—no connectable cell), the control unit 17 ends the process as a connection failure. When it is determined that the cell as the connection destination is the first cell 31 (step S108—first cell connection), the control unit 17 creates the MR of the first cell 31 using the RSRP of the first cell 31. The control unit 17 outputs the created MR of the first cell 31 to the first communication control unit 19. The first baseband control unit 27 of the first communication control unit 19 transmits the MR of the first cell 31 output from the control unit 17 to the base station apparatus 30 via the first communication unit 22 (step S109). The first baseband control unit 27 connects to the first cell 31 on the basis of the information related to the setting of the wireless link to the first cell 31 transmitted from the base station apparatus 30 (step S110).

In the process of step S108, when it is determined that the cell as the connection destination is the second cell 32 (step S108—second cell connection), the control unit 17 creates the MR of the second cell 32 using the RSRP of the second cell 32. The control unit 17 outputs the created MR of the second cell 32 to the second communication control unit 20. The second baseband control unit 29 of the second communication control unit 20 transmits the MR of the second cell 32 output from the control unit 17 to the base station apparatus 30 via the second communication unit 23 (step S111). The second baseband control unit 29 connects to the second cell 32 on the basis of the information related to the setting of the wireless link to the second cell 32 transmitted from the base station apparatus 30 (step S112).

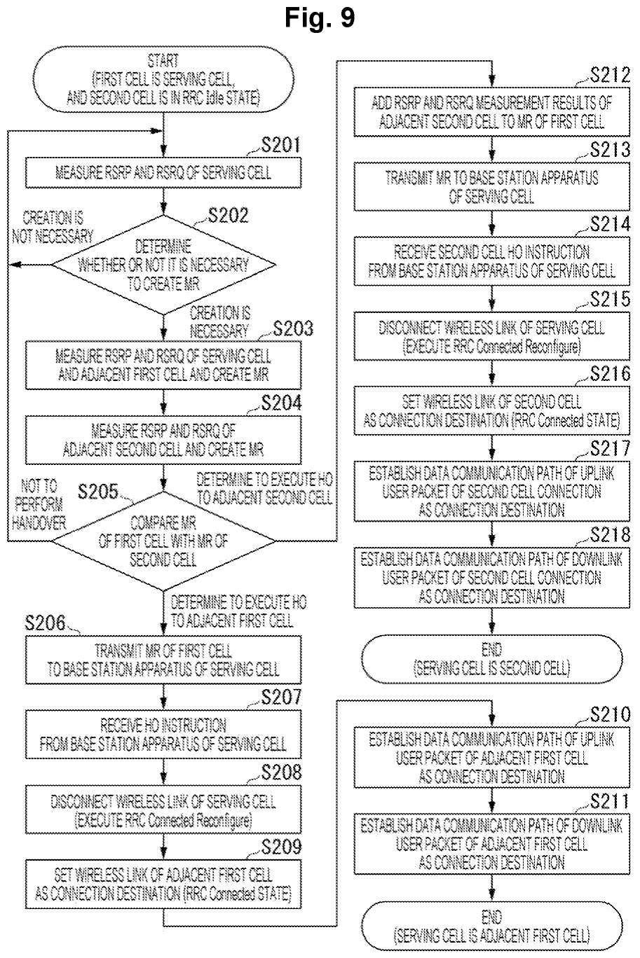

FIG. 9 is a diagram illustrating a flow of handover processing (part 1) of the wireless fixed-line phone router 10 according to the present invention. In FIG. 9, a flow of handover processing triggered by quality degradation of a radio signal in the case illustrated in FIG. 3 will be described. Note that, at the start of the processing in FIG. 9, it is assumed that the first cell 31-1 of the base station apparatus 30-1 is a serving cell and the second cell 32-1 of the base station apparatus 30-1 is in an idle state.

The first baseband control unit 27 measures the RSRP and the RSRQ of the serving cell (for example, the first cell 31-1) (step S201). The first baseband control unit 27 determines whether or not it is necessary to create the MR on the basis of the measured RSRP and RSRQ (step S202). The determination as to whether or not it is necessary to create the MR is the same as in the related art. When it is determined that it is not necessary to create the MR (step S202—NO), the first baseband control unit 27 returns to the process of step S201 and performs the process.

On the other hand, when it is determined that it is necessary to create the MR (step S202—YES), the first baseband control unit 27 measures the RSRP and the RSRQ of the serving cell and the RSRP and the RSRQ of the first cell 31 (hereinafter referred to as the “adjacent first cell 31”) adjacent to the wireless fixed-line phone router 10. The first baseband control unit 27 outputs the measured RSRP and RSRQ to the control unit 17. The control unit 17 creates the MR of the first cell 31 on the basis of the RSRP and the RSRQ output from the first baseband control unit 27 (step S203).

The second baseband control unit 29 measures the RSRP and the RSRQ of the second cell 32 (hereinafter referred to as the “adjacent second cell 32”) adjacent to the wireless fixed-line phone router 10. The second baseband control unit 29 outputs the measured RSRP and RSRQ to the control unit 17. The control unit 17 creates the MR of the second cell 32 on the basis of the RSRP and the RSRQ output from the second baseband control unit 29 (step S203).

The control unit 17 compares the MR of the first cell 31 with the MR of the second cell 32 and determines whether or not to perform handover (step S205). For example, when both of one or more RSRPs included in the MR of the first cell 31 and one or more RSRPs included in the MR of the second cell 32 are less than the threshold value, or when the value of RSRP measured in the serving cell has the highest quality, the control unit 17 determines not to perform handover.

For example, when the value of one or more RSRPs measured in the adjacent first cell 31 included in the MR of the first cell 31 is better in quality than the value of one or more RSRPs included in the MR of the second cell 32, the control unit 17 determines to perform handover to the adjacent first cell 31. In this case, the control unit 17 determines to perform handover to the adjacent first cell 31 having the highest quality.

For example, when the value of one or more RSRPs included in the MR of the second cell 32 is better in quality than the value of one or more RSRPs measured in the adjacent first cell 31 included in the MR of the first cell 31, the control unit 17 determines to perform handover to the adjacent second cell 32. In this case, the control unit 17 determines to perform handover to the adjacent second cell 32 having the highest quality.

When it is determined not to perform handover (step S205—not to perform HO), the control unit 17 performs the processing of step S201. When it is determined to perform handover to the adjacent first cell 31 (step S205—determine to execute HO to the adjacent first cell), the control unit 17 instructs the first communication control unit 19 to transmit the MR. The first baseband control unit 27 of the first communication control unit 19 transmits the MR of the first cell 31 to the base station apparatus 30-1 of the serving cell via the first communication unit 22 according to an instruction from the control unit 17 (step S206).

The first baseband control unit 27 receives an instruction of handover from the base station apparatus 30-1 providing the serving cell via the first communication unit 22 (step S207). The first baseband control unit 27 disconnects the wireless link of the serving cell on the basis of the received instruction of handover (step S208). Thereafter, the first baseband control unit 27 sets the wireless link of the first cell 31 as a new connection destination on the basis of the information regarding the setting of the wireless link included in the instruction of handover (step S209).

After completing the setting of the wireless link, the wireless fixed-line phone router 10 establishes a data communication path of the uplink user packet of the first cell 31 as the new connection destination (step S210). After completing the setting of the wireless link, the wireless fixed-line phone router 10 establishes a data communication path of the downlink user packet of the first cell 31 as the new connection destination (step S211). In this case, the serving cell is a first cell 31-2 of the base station apparatus 30-2.

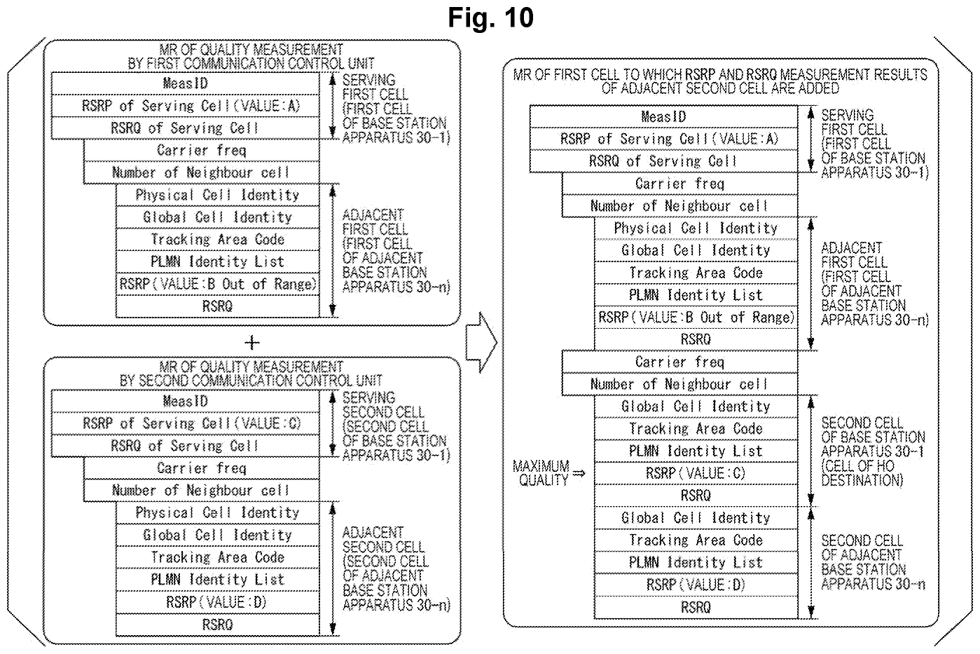

In the process of step S205, when the control unit 17 determines to perform handover to the adjacent second cell 32 (step S205—determine to execute HO to the adjacent second cell), the control unit 17 adds measurement results included in the MR of the second cell 32 to the MR of the first cell 31 to create a new MR (step S212). FIG. 10 is a diagram illustrating an example of the MR created using the MR of the first cell 31 and the MR of the second cell 32. As illustrated in FIG. 10, the measurement results included in the MR of the second cell 32 are added to the MR of the first cell 31. In the example illustrated in FIG. 10, when the value of RSRP is “C>A>D>B” or “C>D>A>B” (when the value: C is the best quality), it is indicated that the second cell 32 of the base station apparatus 30-1 has the maximum quality.

The control unit 17 outputs the created MR to the second communication control unit 20. The second baseband control unit 29 of the second communication control unit 20 transmits the MR output from the control unit 17 to the base station apparatus 30-1 of the serving cell via the second communication unit 23 (step S213). The second baseband control unit 29 receives an instruction of handover from the base station apparatus 30-1 providing the serving cell via the second communication unit 23 (step S214). The second baseband control unit 29 disconnects the wireless link of the serving cell on the basis of the received instruction of handover (step S215). Thereafter, the second baseband control unit 29 sets the wireless link of the second cell 32 of the base station apparatus 30-1 as a new connection destination on the basis of the information regarding the setting of the wireless link included in the instruction of handover (step S216).

After completing the setting of the wireless link, the wireless fixed-line phone router 10 establishes a data communication path of the uplink user packet of the second cell 32 as the new connection destination (step S217). After completing the setting of the wireless link, the wireless fixed-line phone router 10 establishes a data communication path of the downlink user packet of the second cell 32 as the new connection destination (step S218). In this case, the serving cell is the second cell 32-2 of the base station apparatus 30-1.

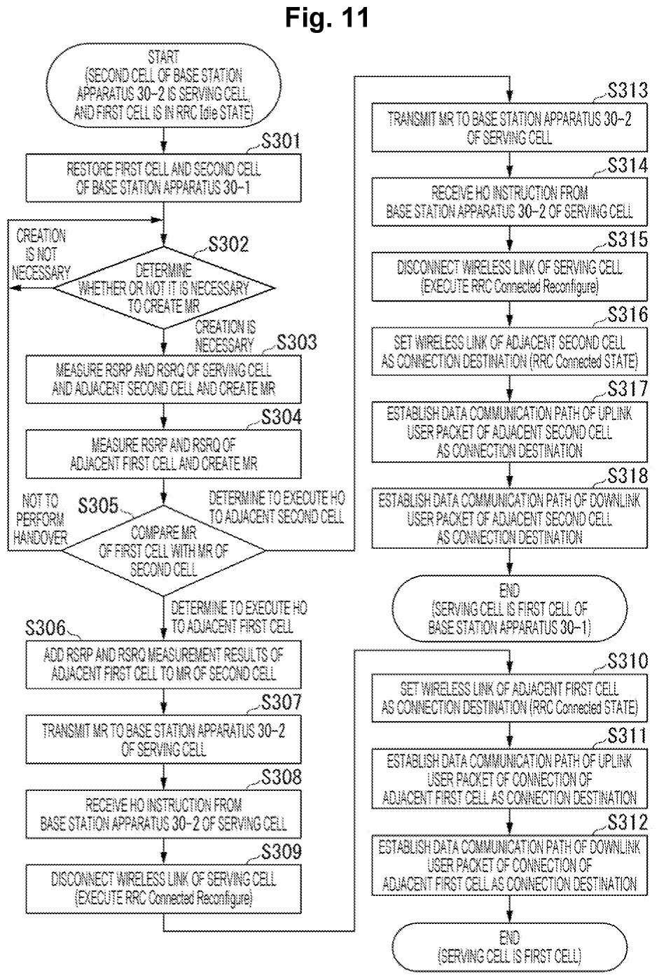

FIG. 11 is a diagram illustrating a flow of handover processing (part 2) of the wireless fixed-line phone router 10 according to the present invention. In FIG. 11, a flow of handover processing using recovery of a cell suspended due to a failure as a trigger in the case illustrated in FIG. 7 will be described. Note that, at the start of the processing in FIG. 11, it is assumed that the second cell 32-2 of the base station apparatus 30-2 is a serving cell and the first cell 31-2 of the base station apparatus 30-2 is in an idle state.

It is assumed that the first cell 31-1 and the second cell 32-1 provided by the base station apparatus 30-1 are restored (step S301). The wireless fixed-line phone router 10 determines the recovery of the first cell 31-1 and second cell 32-1 of the base station apparatus 30-1 in response to reception of a reference signal transmitted from the first cell 31-1, for example. The control unit 17 determines whether or not it is necessary to create the MR according to the recovery of the first cell 31-1 and the second cell 32-1 of the base station apparatus 30-1 (step S302). The control unit 17 may determine that it is necessary to create the MR when the radio quality of the current serving cell is less than the threshold value, or may determine that it is necessary to create the MR when the original connection destination is a different base station apparatus 30 (for example, the base station apparatus 30-1).

When it is determined that it is not necessary to create the MR (step S302—NO), the control unit 17 returns to the process of step S302 and performs the process.

On the other hand, when it is determined that it is necessary to create the MR (step S302—YES), the control unit 17 instructs the first communication control unit 19 and the second communication control unit 20 to measure the RSRP and the RSRQ. The second baseband control unit 29 of the second communication control unit 20 measures the RSRP and the RSRQ of the serving cell (for example, the second cell 32-2) and the RSRP and the RSRQ of the adjacent second cell 32. The second baseband control unit 29 outputs the pluralities of measured RSRPs and RSRQs to the control unit 17. The control unit 17 creates the MR of the second cell 32 on the basis of the pluralities of RSRPs and RSRQs output from the second baseband control unit 29 (step S303).

The first baseband control unit 27 measures the RSRP and the RSRQ of the adjacent first cell 31. The first baseband control unit 27 outputs the pluralities of measured RSRPs and RSRQs to the control unit 17. The control unit 17 creates the MR of the first cell 31 on the basis of the pluralities of RSRPs and RSRQs output from the first baseband control unit 27 (step S304).

The control unit 17 compares the MR of the first cell 31 with the MR of the second cell 32 and determines whether or not to perform handover (step S305). When it is determined not to perform handover (step S305—not to perform HO), the control unit 17 performs the processing of step S302. When it is determined to perform handover to the adjacent first cell 31 (step S305—determine to execute HO to the adjacent first cell), the control unit 17 adds measurement results included in the MR of the first cell 31 to the MR of the second cell 32 to create a new MR (step S306).

The control unit 17 outputs the created MR to the first communication control unit 19. The first baseband control unit 27 of the first communication control unit 19 transmits the MR output from the control unit 17 to the base station apparatus 30-2 of the serving cell via the first communication unit 22 (step S307). The first baseband control unit 27 receives an instruction of handover from the base station apparatus 30-2 providing the serving cell via the first communication unit 22 (step S308). The first baseband control unit 27 disconnects the wireless link of the serving cell on the basis of the received instruction of handover (step S309). Thereafter, the first baseband control unit 27 sets the wireless link of the first cell 31-1 of the newly connected base station apparatus 30-1 on the basis of the information regarding the setting of the wireless link included in the instruction of handover (step S310).

After completing the setting of the wireless link, the wireless fixed-line phone router 10 establishes a data communication path of the uplink user packet of the first cell 31-1 as the new connection destination (step S311). After completing the setting of the wireless link, the wireless fixed-line phone router 10 establishes a data communication path of the downlink user packet of the first cell 31-1 as the new connection destination (step S312). In this case, the serving cell is the first cell 31-1 of the base station apparatus 30-1.

In the process of step S305, when the control unit 17 determines to perform handover to the adjacent second cell 32 (step S305—determine to execute HO to the adjacent second cell), the control unit 17 instructs the second communication control unit 20 to transmit the MR. The second baseband control unit 29 of the second communication control unit 20 transmits the MR of the second cell 32 to the base station apparatus 30-2 of the serving cell via the second communication unit 23 according to the instruction from the control unit 17 (step S313).

The second baseband control unit 29 receives an instruction of handover from the base station apparatus 30-2 providing the serving cell via the second communication unit 23 (step S314). The second baseband control unit 29 disconnects the wireless link of the serving cell on the basis of the received instruction of handover (step S315). Thereafter, the second baseband control unit 29 sets the wireless link of the second cell 32-1 as the new connection destination on the basis of the information regarding the setting of the wireless link included in the instruction of handover (step S316).

After completing the setting of the wireless link, the wireless fixed-line phone router 10 establishes a data communication path of the uplink user packet of the second cell 32-1 as the new connection destination (step S317).

After completing the setting of the wireless link, the wireless fixed-line phone router 10 establishes a data communication path of the downlink user packet of the second cell 32-1 as the new connection destination (step S318). In this case, the serving cell is the second cell 32-1 of the base station apparatus 30-1.

### Second Operation Example

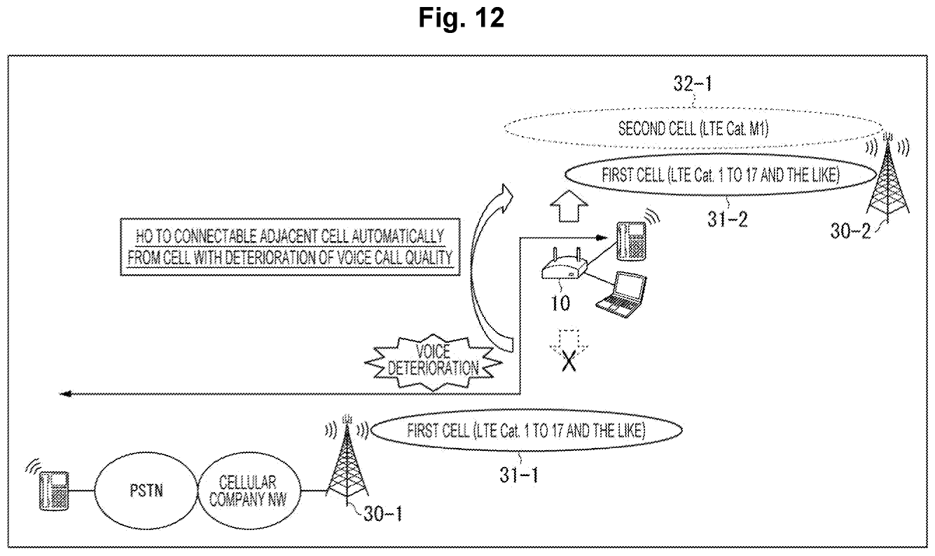

Next, as a second operation example of the wireless fixed-line phone router 10, processing at the time of a voice call using an audio signal input from the subscriber phone 52 will be described. FIG. 12 is a diagram for describing an overview of processing of the wireless fixed-line phone router 10 in the second operation example. As illustrated in FIG. 12, it is assumed that a user makes a voice call with another user via the wireless fixed-line phone router 10 connected to the first cell 31-1 provided by the base station apparatus 30-1. The wireless fixed-line phone router 10 monitors packet loss, packet delay, and packet jitter of voice communication to monitor deterioration of voice communication quality during a voice call.

Upon detecting voice call quality deterioration (any one of packet loss, packet delay, and packet jitter is less than the threshold value), the control unit 17 of the wireless fixed-line phone router 10 performs handover execution determination by adding voice call quality deterioration information to the signal strength (RSRP) and the signal quality (RSRQ) of the reception reference signal of the serving cell, and performs handover to the connectable adjacent cell to maintain and improve the voice call quality. The voice call quality deterioration information is a value added to measured RSRP and RSRQ on the basis of packet loss, packet delay, or packet jitter.

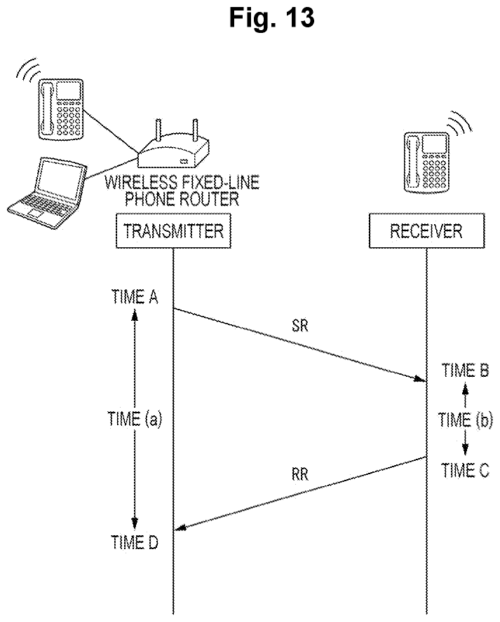

FIG. 13 is a diagram for describing an example of a method of monitoring voice call quality deterioration using voice communication RTCP information. In VOLTE communication, real-time transport protocol (RTP) and RTP control protocol (RTCP) are used for voice data communication. According to the receiver report (RR) of the RTCP, a round-trip delay time (round-trip time (RTT)) can be obtained on the basis of the information (packet loss rate and packet interval jitter) on the reception quality at the receiver and the reception time of the transmitter report (SR) and the reception time of the RR. For example, the round-trip delay time (RTT) is calculated on the basis of the following Expression (1).

[Math. 1]

ROUND-TRIP DELAY TIME (RTT)=TIME (a)−TIME (b)=RR RECEPTION TIME D−LSR (TIME A)−DLSR (TIME (b)) EXPRESSION (1)

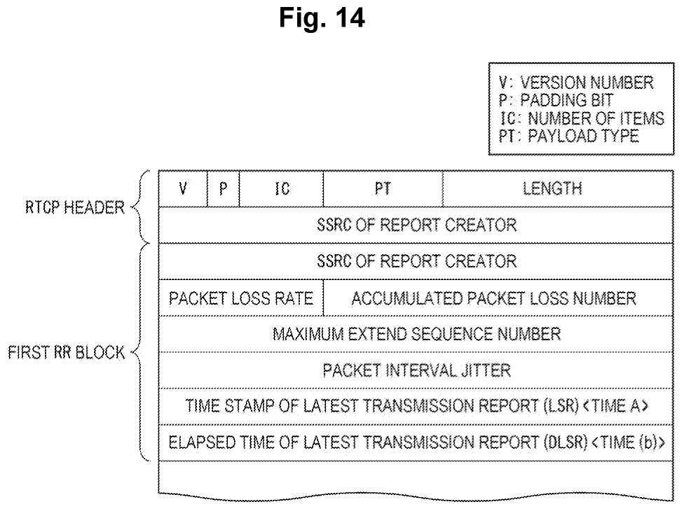

FIG. 14 is a diagram illustrating an example of a format of an RTCP receiver report packet in the second operation example. As illustrated in FIG. 14, the RTCP receiver report packet includes an RTCP header and one or more RR blocks. The RTCP header includes a version number, a padding hit, the number of items, a payload type, a packet length, and SSRC information of a report creator. The one or more RR blocks include the packet loss rate and the packet interval jitter, which are information regarding the reception quality, and information used for calculating the RTT.

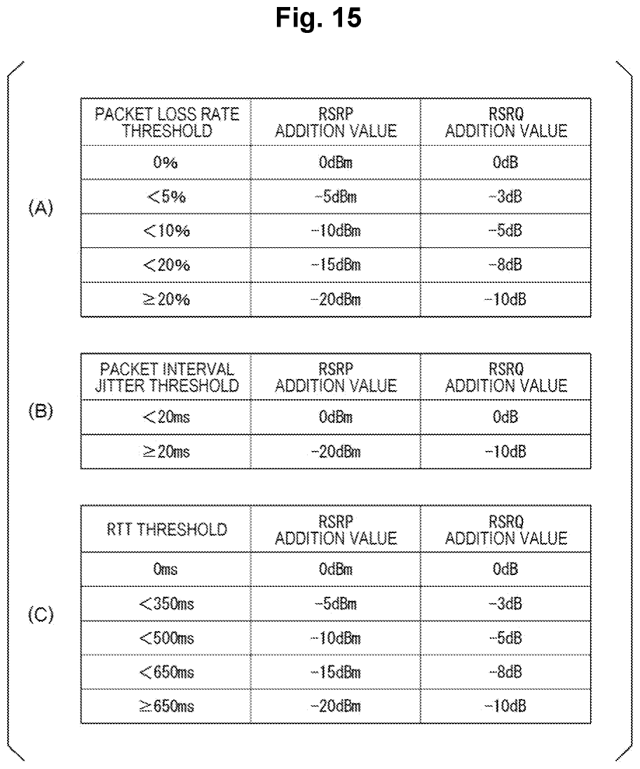

FIG. 15 is a diagram for describing a method of reflecting the voice call quality deterioration information on the MR at the time of handover due to the voice call quality deterioration in the second operation example. In FIGS. 15(A) to 15(C), respective threshold values for the packet loss rate, the packet interval jitter, and the RTT, an addition value to RSRP, and an addition value to RSRQ are associated with each other. The addition value to the RSRP is a value added to the RSRP measured in the serving cell. The addition value to the RSRQ is a value added to the RSRQ measured in the serving cell.

For example, in the table illustrated in FIG. 15(A), a packet loss rate threshold value, an addition value to RSRP, and an addition value to RSRQ are associated with each other. The table illustrated in FIG. 15(A) indicates that, when the packet loss rate is higher than 0% and lower than 5%, a value of −5 dBm is added to the RSRP measured in the serving cell, and a value of −3 dB is added to the RSRQ measured in the serving cell.

For example, in the table illustrated in FIG. 15(B), the packet interval jitter threshold value, the addition value to RSRP, and the addition value to RSRQ are associated with each other. According to the table illustrated in FIG. 15(B), when the packet interval jitter is less than 20 ms, a value of 0 dBm is added to the RSRP measured in the serving cell, and a value of 0 dB is added to the RSRQ measured in the serving cell.

For example, in the table illustrated in FIG. 15(C), an RTT threshold value, an addition value to RSRP, and an addition value to RSRQ are associated with each other. The table illustrated in FIG. 15(C) indicates that, when the RTT is higher than 0 ms and lower than 350 ms, a value of-5 dBm is added to the RSRP measured in the serving cell, and a value of −3 dB is added to the RSRQ measured in the serving cell.

Next, calculation examples of RSRP and RSRQ using the tables illustrated in FIGS. 15(A) to 15(C) will be described. As a first example, it is assumed that the packet loss rate is 6%, the packet interval jitter is 15 ms, and the RTT is 100 ms. In this case, the value added to the RSRP measured in the serving cell is −5 dBm−0 dBm−0 dBm=−5 dBm. The value added to the measured RSRQ in the serving cell is −3 dBm−0 dBm−0 dBm=−3 dBm.

As another example, it is assumed that the packet loss rate is 6%, the packet interval jitter is 20 ms, and the RTT is 400 ms. In this case, the value added to the RSRP measured in the serving cell is −5 dBm−20 dBm−5 dBm =−30 dBm. The value added to the measured RSRQ in the serving cell is −3 dBm−10 dBm−3 dBm=−16 dBm.

Hereinafter, tables illustrated in FIGS. 15(A) to 15(C) are referred to as threshold value tables.

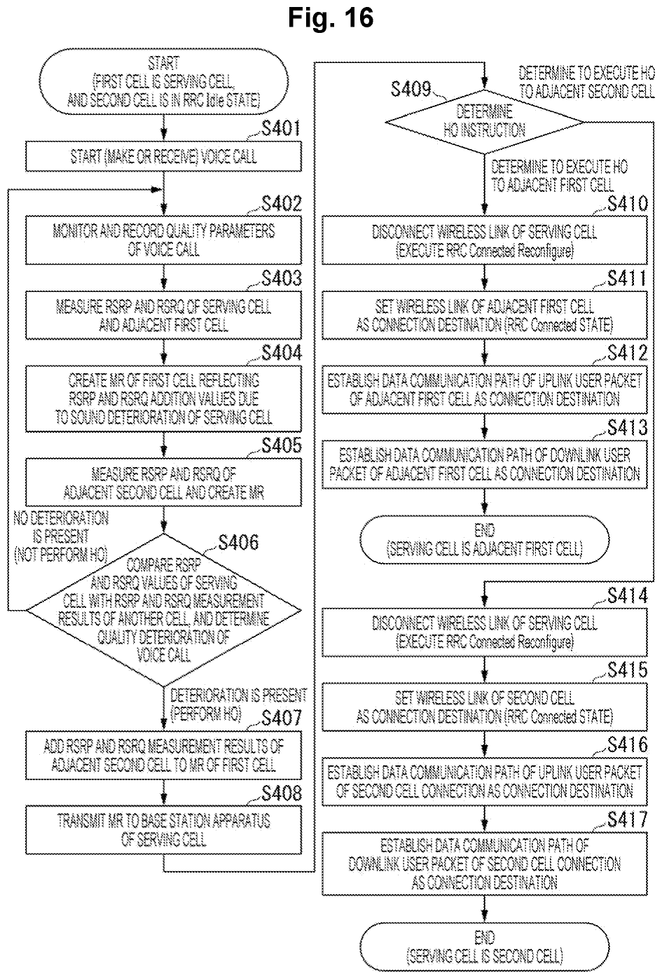

FIG. 16 is a diagram illustrating a flow of handover processing (part 3) of the wireless fixed-line phone router 10 according to the present invention. In FIG. 16, a flow of handover processing using voice call quality deterioration during a voice call as a trigger in the case illustrated in FIG. 12 will be described. Note that, at the start of the processing in FIG. 16, it is assumed that the first cell 31-1 of the base station apparatus 30-1 is a serving cell and the second cell 32-1 of the base station apparatus 30-1 is in an idle state.

It is assumed that the user starts (makes or receives) a voice call using the subscriber phone 52 (step S401). A voice call made or received by the subscriber phone 52 is made via the wireless fixed-line phone router 10. The control unit 17 of the wireless fixed-line phone router 10 monitors quality parameters of the voice call. For example, the control unit 17 snoops the RTCP content of the voice call, acquires the average values of the packet loss rate, the packet interval jitter, and the RTT of the voice call RTP at fixed time intervals (for example, at intervals of 60 seconds), and records the average values in the storage unit 18 (step S402).

The first baseband control unit 27 measures the RSRP and the RSRQ of the serving cell and the RSRP and the RSRQ of the adjacent first cell 31. The first baseband control unit 27 outputs the pluralities of measured RSRPs and RSRQs to the control unit 17. The control unit 17 creates the MR of the first cell 31 reflecting the RSRP addition value and the RSRQ addition value due to deterioration of sound in the serving cell on the basis of the pluralities of RSRPs and RSRQs output from the first baseband control unit 27, the audio quality parameters recorded in the storage unit 18, and the respective threshold value tables illustrated in FIGS. 15(A) to 15(C) (step S404). Note that only the RSRP and the RSRQ measured in the serving cell are to be reflected with the RSRP addition value and the RSRQ additional value. That is, the RSRP addition value and the RSRQ addition value are not reflected on the RSRP and the RSRQ measured in the adjacent first cell 31.

The second baseband control unit 29 measures the RSRP and the RSRQ of the adjacent second cell 32. The second baseband control unit 29 outputs the measured RSRP and RSRQ to the control unit 17. The control unit 17 creates the MR of the second cell 32 on the basis of the pluralities of RSRPs and RSRQs output from the second baseband control unit 29 (step S405).

The control unit 17 compares the values of the RSRP and the RSRQ of the serving cell included in the MR of the first cell 31, the values of the RSRP and the RSRQ of the adjacent first cell 31, and the values of the RSRP and the RSRQ included in the MR of the second cell 32 and determines whether the quality of the voice communication is deteriorated (step S406). When the values of the RSRP and the RSRQ of the serving cell are less than the threshold values, or when the values of the RSRP and the RSRQ of the serving cell are lower than any of the values of the RSRP and the RSRQ of the adjacent first cell 31 or the values of the RSRP and the RSRQ included in the MR of the second cell 32, the control unit 17 determines that the quality of the voice communication has deteriorated. When it is determined that the quality of the voice communication has deteriorated, the control unit 17 determines that handover needs to be performed.

On the other hand, when the values of the RSRP and the RSRQ of the serving cell are equal to or larger than the values of the RSRP and the RSRQ of the adjacent first cell 31 and the values of the RSRP and the RSRQ included in the MR of the second cell 32, the control unit 17 determines that the quality of the voice communication is not deteriorated. When it is determined that the quality of the voice communication is not deteriorated, the control unit 17 determines that handover does not need to be performed.

When it is determined that the quality of the voice communication is not deteriorated (step S406-No deterioration (no HO)), the control unit 17 performs the process of step S402 and subsequent steps.

On the other hand, when it is determined that the quality of the voice communication has deteriorated (step S406—deterioration is present (HO)), the control unit 17 adds the measurement results included in the MR of the second cell 32 to the MR of the first cell 31 to create a new MR (step S407). The control unit 17 instructs the first communication control unit 19 to transmit the created new MR to the base station apparatus 30 of the serving cell.

The first communication control unit 19 transmits the MR output from the control unit 17 to the base station apparatus 30 of the serving cell (the first cell 31-1) according to the instruction of the control unit 17 (step S408). Thus, the base station apparatus 30 determines a new connection destination of the wireless fixed-line phone router 10. When the control unit 17 receives an instruction of handover from the base station apparatus 30, the control unit 17 determines the received handover instruction (step S409). For example, the control unit 17 determines whether the received handover instruction is a handover instruction to the adjacent first cell 31 or a handover instruction to the adjacent second cell 32.

When the received handover instruction is a handover instruction to the adjacent first cell 31 (step S409—determine to execute HO to the adjacent first cell), the first baseband control unit 27 disconnects the wireless link of the serving cell on the basis of the received instruction of handover (step S410). Thereafter, the first baseband control unit 27 sets the wireless link of the first cell 31-2 of the base station apparatus 30-2 as a new connection destination on the basis of the information regarding the setting of the wireless link included in the instruction of handover (step S411).

After completing the setting of the wireless link, the wireless fixed-line phone router 10 establishes a data communication path of the uplink user packet of the first cell 31-2 as the new connection destination (step S412). After completing the setting of the wireless link, the wireless fixed-line phone router 10 establishes a data communication path of the downlink user packet of the first cell 31-2 as the new connection destination (step S413). In this case, the serving cell is the first cell 31-2 of the base station apparatus 30-2.

In the process of step S409, when the received handover instruction is a handover instruction to the adjacent second cell 32 (step S409—determine to execute HO to the adjacent second cell), the second baseband control unit 29 disconnects the wireless link of the serving cell on the basis of the received instruction of handover (step S414). Thereafter, the second baseband control unit 29 sets the wireless link of the second cell 32-2 as the new connection destination on the basis of the information regarding the setting of the wireless link included in the instruction of handover (step S415).

After completing the setting of the wireless link, the wireless fixed-line phone router 10 establishes a data communication path of the uplink user packet of the second cell 32-2 as the new connection destination (step S416). After completing the setting of the wireless link, the wireless fixed-line phone router 10 establishes a data communication path of the downlink user packet of the second cell 32-2 as the new connection destination (step S417). In this case, the serving cell is the second cell 32-2 of the base station apparatus 30-2.

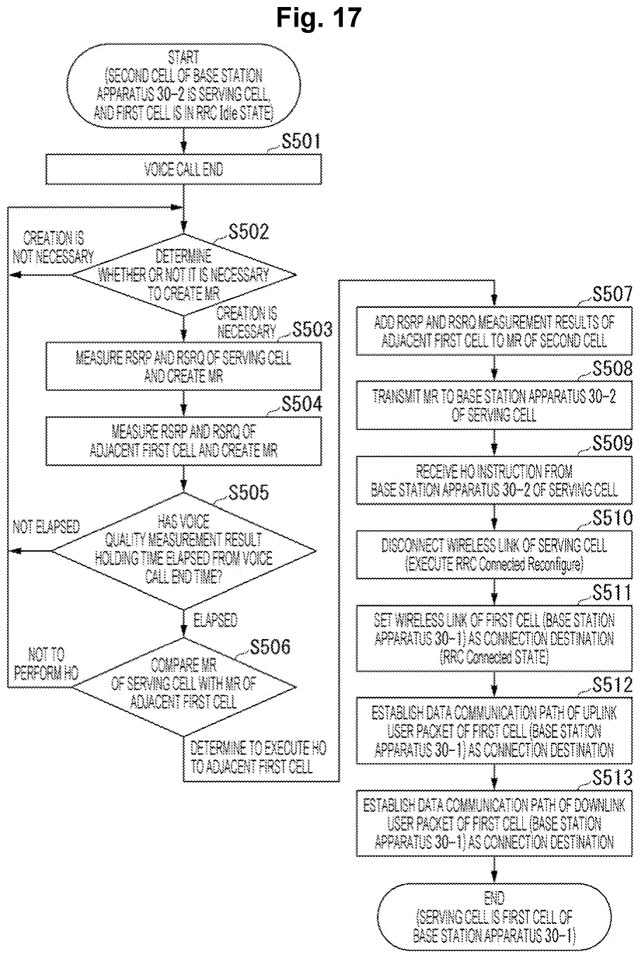

FIG. 17 is a diagram illustrating a flow of handover processing (part 4) of the wireless fixed-line phone router 10 according to the present invention. In FIG. 17, a flow of handover processing at the end of a voice call will be described. Note that, at the start of the processing in FIG. 17, it is assumed that the second cell 32-2 of the base station apparatus 30-2 is a serving cell and the first cell 31-2 of the base station apparatus 30-2 is in an idle state.

It is assumed that the voice call of the user is ended (step S501). The wireless fixed-line phone router 10 determines whether or not it is necessary to create the MR corresponding to the end of the voice call of the user (step S302). The control unit 17 may determine that it is necessary to create the MR when the audio quality of the current serving cell is less than the threshold value, or may determine that it is necessary to create the MR when the original connection destination is a different base station apparatus 30 (for example, the base station apparatus 30-1).

When it is determined that it is not necessary to create the MR (step S502—NO), the control unit 17 returns to the process of step S502 and performs the process.

On the other hand, when it is determined that it is necessary to create the MR (step S302—YES), the control unit 17 instructs the first communication control unit 19 and the second communication control unit 20 to measure the RSRP and the RSRQ. The second baseband control unit 29 of the second communication control unit 20 measures the RSRP and the RSRQ of the serving cell (for example, the second cell 32-2). The second baseband control unit 29 outputs the measured RSRP and RSRQ to the control unit 17. The control unit 17 creates the MR of the second cell 32 on the basis of the RSRP and the RSRQ output from the second baseband control unit 29 (step S503).

The first baseband control unit 27 measures the RSRP and the RSRQ of the adjacent first cell 31. The first baseband control unit 27 outputs the pluralities of measured RSRPs and RSRQs to the control unit 17. The control unit 17 creates the MR of the first cell 31 on the basis of the pluralities of RSRPs and RSRQs output from the first baseband control unit 27 (step S504).

The control unit 17 determines whether or not an audio quality measurement result holding time has elapsed from a voice call end time (step S505). The audio quality measurement result holding time is a holding time of the audio quality parameter recorded in the storage unit 18. When the audio quality measurement result holding time has elapsed, the control unit 17 deletes the audio quality parameter recorded in the storage unit 18. When it is determined that the audio quality measurement result holding time has not elapsed from the voice call end time (step S505—not elapsed), the control unit 17 executes the process of step S502 and subsequent steps.

When it is determined that the audio quality measurement result holding time has elapsed from the voice call end time (step S505—elapsed), the control unit 17 deletes the audio quality parameter recorded in the storage unit 18. Thereafter, the control unit 17 compares the MR including the information of the serving cell with the MR of the first cell 31 and determines whether or not to perform handover to the adjacent first cell 31 (step S506). For example, when the values of the RSRP and the RSRQ of the serving cell are higher than the values of the RSRP and the RSRQ included in the MR of the first cell 31, the control unit 17 determines not to perform handover to the adjacent first cell 31. On the other hand, the control unit 17 determines to perform handover to the adjacent first cell 31 when any of the values of RSRP and RSRQ included in the MR of the first cell 31 is higher than the values of RSRP and RSRQ of the serving cell.

When it is determined not to perform handover (step S506—not to perform HO), the control unit 17 performs the process of step S502.

On the other hand, when it is determined to perform handover to the adjacent first cell 31 (step S506—determine to execute HO to the adjacent first cell), the control unit 17 adds the measurement result included in the MR of the first cell 31 to the MR of the second cell 32 and creates a new MR (step S507). The control unit 17 outputs the created new MR to the first communication control unit 19.

The first baseband control unit 27 of the first communication control unit 19 transmits the new MR output from the control unit 17 to the base station apparatus 30-2 of the serving cell via the first communication unit 22 (step S508). The first baseband control unit 27 receives an instruction of handover from the base station apparatus 30-2 providing the serving cell via the first communication unit 22 (step S509). The first baseband control unit 27 disconnects the wireless link of the serving cell on the basis of the received instruction of handover (step S510). Thereafter, the first baseband control unit 27 sets the wireless link of the first cell 31-1 of the base station apparatus 30-1 as a new connection destination on the basis of the information regarding the setting of the wireless link included in the instruction of handover (step S511).

After completing the setting of the wireless link, the wireless fixed-line phone router 10 establishes a data communication path of the uplink user packet of the first cell 31-1 as the new connection destination (step S512). After completing the setting of the wireless link, the wireless fixed-line phone router 10 establishes a data communication path of the downlink user packet of the first cell 31-1 as the new connection destination (step S513). In this case, the serving cell is the first cell 31-1 of the base station apparatus 30-1.

According to the wireless fixed-line phone router 10 configured as described above, when a failure of the connected base station apparatus 30 or deterioration of the radio quality of the serving cell occurs, handover is performed to a connectable neighboring cell by the LTE Cat. M1 coverage enhancement function. Thus, it is possible to maintain minimum communication necessary for a wireless fixed-line phone.

Some functions of the wireless fixed-line phone router 10 described above may be implemented by a computer. In that case, a program for implementing these functions may be recorded in a computer-readable recording medium, and the program recorded in the recording medium may be read and executed by a computer system to implement the functions. Note that the “computer system” mentioned herein includes an OS and hardware such as peripheral devices. In addition, the “computer-readable recording medium” refers to a portable medium such as a flexible disk, a magneto-optical disc, a ROM, or a CD-ROM, or a storage device such as a hard disk included in the computer system.

Further, the “computer-readable recording medium” may include a medium that dynamically stores the program for a short time, such as a communication line in a case where the program is transmitted via a network such as the Internet or a communication line such as a telephone line, and a medium that stores the program for a certain period of time, such as a volatile memory inside the computer system serving as a server or a client in that case. Also, the foregoing program may be for implementing some of the functions described above, may be implemented in a combination of the functions described above and a program already recorded in a computer system, or may be implemented with a programmable logic device such as a field programmable gate array (FPGA).

Although the embodiments of the present invention have been described in detail with reference to the drawings, specific configurations are not limited to the embodiments, and include design and the like within the scope of the present invention without departing from the gist of the present invention.

### INDUSTRIAL APPLICABILITY

The present invention can be applied to a technology using a wireless fixed-line phone.

### REFERENCE SIGNS LIST

10 Wireless fixed-line phone router
11 Ethernet interface circuit
12 Subscriber line interface circuit
13 Ethernet control unit
14 Audio encoding/decoding unit
15 FAX encoding/decoding unit
16 Application software unit
17 Control unit
18 Storage unit
19 First communication control unit
Second communication control unit
21 Subscriber information recording medium
22 First communication unit
23 Second communication unit
24 Antenna
25 Antenna
26 First communication control software unit
27 First baseband control unit
28 Second communication control software unit
29 Second baseband control unit
30 Base station apparatus
51 FAX
52 Subscriber phone
53 PC

1. A wireless fixed-line phone router to which at least a wireless fixed-line phone is connected, the wireless fixed-line phone router comprising:
a first communication unit that performs communication according to a first mobile communication standard;
a second communication unit that performs communication according to a second mobile communication standard that is a mobile communication standard different from the first mobile communication standard and is capable of performing communication in a wider range than the first mobile communication standard; and
a control unit that causes the second communication unit to perform communication in a case where communication quality deteriorates when the first communication unit performs communication.

2. The wireless fixed-line phone router according to claim 1, wherein the control unit compares information of communication quality obtained in a first area where communication according to the first mobile communication standard is possible with information of communication quality obtained in a second area where communication according to the second mobile communication standard is possible, and determines which of the first communication unit and the second communication unit performs communication.

3. The wireless fixed-line phone router according to claim 2, wherein
the communication quality includes at least one of signal strength or signal quality, and information regarding audio quality during a call, and
the control unit determines which one of the first communication unit or the second communication unit performs communication by using a result obtained by adding the information regarding the audio quality to the signal strength or the signal quality measured in the first area or the second area provided by a base station apparatus being connected.

4. A communication control method performed by a wireless fixed-line phone router to which at least a wireless fixed-line phone is connected, the communication control method comprising:
performing communication according to a first mobile communication standard;
performing communication according to a second mobile communication standard that is a mobile communication standard different from the first mobile communication standard and is capable of performing communication in a wider range than the first mobile communication standard; and
causing communication to be performed according to the second mobile communication standard in a case where communication quality deteriorates when communication is performed according to the first mobile communication standard.

5. A non-transitory computer-readable medium having computer-executable instructions that, upon execution of the instructions by a processor of a computer, cause the computer to function as the wireless fixed-line phone router according to claim 1.
